(19) United States
(12) Patent Application Publication
(10) Pub. No.: US 2012/0310913 A1
(43) Pub. Date: Dec. 6, 2012

(54) System and method to access a plurality of document results pages

(76) Inventors: Jaimie Sirovich, West Nyack, NY (US); Eli Penzias, Monsey, NY (US)

(21) Appl. No.: 13/483,019

(22) Filed: May 29, 2012

Related U.S. Application Data
(60) Provisional application No. 61/491,273, filed on May 30, 2011.
(60) Provisional application No. 61/492,975.
(60) Provisional application No. 61/497,409, filed on Jun. 15, 2011.

(51) Int. Cl. G06F 17/30

(52) U.S. Cl. 707/710; 707/E17.108

(57) ABSTRACT

The present invention is a system to permit access to document result pages on a domain or subdomain using a domain or a subdomain URL with a search engine, a user defined list that is utilized to enable any document result pages visibility and a first component that saves and transfers the document result pages to a web server. Web search engines may address the document result pages exactly as a human does, using the same URLs, on any desired domain or subdomain, including the main web site domain. There is also a second component where the document result pages are manually transferred to the web server and a plurality of browser based scripts that are inserted into the website HTML text to update the browser's displayed URL to a corresponding URL that accesses a particular document result page that is transferred to the web server.

This application claims priority to U.S. Provisional Application 61/491,273 filed on May 30, 2011, U.S. Provisional Application 61/492,975 filed on Jun. 3, 2011 and U.S. Provisional Application 61/497,409 filed on Jun. 15, 2011 the entire disclosure of which is incorporated by reference.

### TECHNICAL FIELD & BACKGROUND

Current externally-hosted faceted navigation and search engines that can be integrated with only HTML and browser-based scripts (i.e., JavaScript) do not provide a method for web search engines (i.e., Google, Yahoo and Bing) to address the document result pages exactly as the human does, using the same URLs, on any desired domain or subdomain, including the main web site domain (i.e., example business.com or www.examplebusiness.com). They either do not allow web search engines to address content at all, or require the use of an additional subdomain that both humans and web search engines use to address the document result pages, (i.e., search.examplebusiness.com).

It is an object of the present invention to provide a plurality of web search engines the ability to address a plurality of document result pages in a similar fashion as a human does, using the same URLs, on any desired domain or subdomain, including the main web site domain.

What are really needed are an externally-hosted search engine and its related software, in coordination with a plurality of browser-based scripts (i.e., JavaScript) installed and integrated on a web site to provide a consistent view, using the same URLs, for both humans and web search engines. By this method, the externally-hosted search engine may be used with any web site that allows changes to its HTML template text. This also enables its use on many web sites that do not provide full access to modify source code.

### BRIEF DESCRIPTION OF THE DRAWINGS

The present invention will be described by way of exemplary embodiments, but not limitations, illustrated in the accompanying drawing in which like references denote similar elements, and in which:

FIG. 1 illustrates a block diagram of a system to permit access to a plurality of document result pages on a selected one of a domain and a subdomain using a selected one of a domain and a subdomain URL, in accordance with one embodiment of the present invention.

FIG. 2 illustrates a flow chart of a method for accessing a plurality of document result pages on a selected one of a domain and a subdomain using a selected one of a domain and a subdomain URL, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

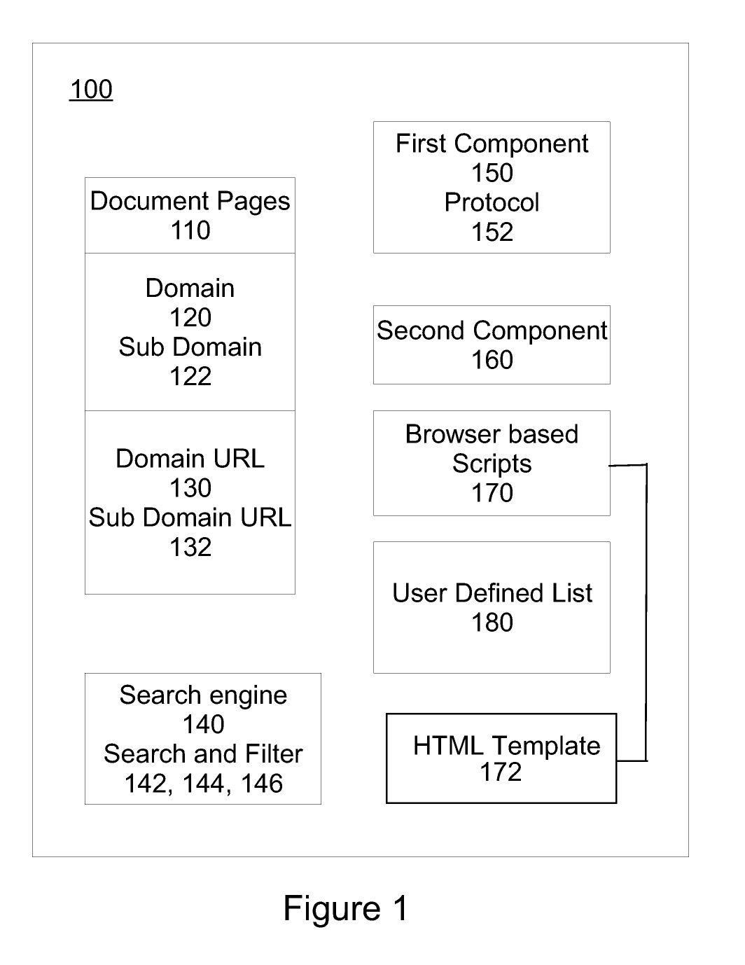

FIG. 1 illustrates a block diagram of a system 100 to permit access to a plurality of document result pages 110 on a selected one of a domain 120 and a subdomain 122 using a selected one of a domain URL 130 and a subdomain URL 132, in accordance with one embodiment of the present invention. The system 100 includes a plurality of document result pages 110 on a selected one of a domain 120 and a subdomain 122 using a selected one of a domain URL 130 and a subdomain URL 132, a search engine 140 with a full text search 142 and/or category filter 144 and facet filter capability 146, a first component 150 that saves and transfers the document result pages to a web server using a file transfer protocol 152, a second component 160 where the document result pages are manually transferred to the web server and a plurality of browser based scripts 170 that are inserted into the website HTML text with a web site HTML template 172 to update the browser's URL to any URL that accesses a particular document result page that is transferred to the web server. The HTML template 172 is changed to include a plurality of browser based scripts 170.

The search engine 140 supports a full text search or filter capability 142 that includes a plurality of categories 144 and a plurality of facet filters 146. The file transfer protocol 152 is selected from the group consisting of a FTP, a SCP, a SFTP, a FTPS, a HTTPS or a HTTP protocol. The document result pages 110 each have a specified file name, which can also be generated automatically. The browser and web search engine may address the document result page with this specified file name or utilize a default indexable URL and access the document result pages 110 on a selected one of a main web site domain 120 and a subdomain 122. The system 100 also may include a user defined list 180 that is utilized to enable or disable any document result pages 110 visibility to the web search engines. The user defined list 180 also includes any desirable content or can exclude any undesirable content from web search engines. When the document result pages 110 from the user defined list 180 are transferred with first component 150 there is also a configurable total limit of the document result pages that can be transferred. The system 100 can also track changes in search engine data and can automatically transfer new updated and altered document result pages.

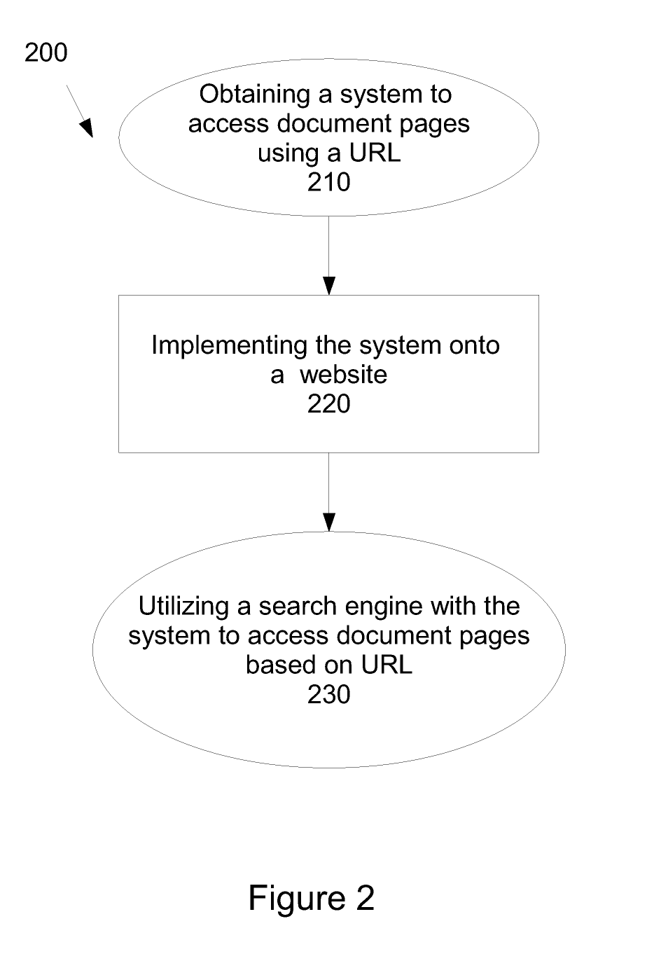

FIG. 2 illustrates a flow chart of a method 200 for accessing a plurality of document result pages on a selected one of a domain and a subdomain using a selected one of a domain and a subdomain URL, in accordance with one embodiment of the present invention. The method 200 for accessing a plurality of document result pages on a selected one of a domain and a subdomain using a selected one of a domain and a subdomain URL includes the steps of obtaining a system to access a plurality of document result pages on a selected one of a domain and a subdomain using a selected one of a domain and a subdomain URL 210, implementing the system onto a website 220 and utilizing a search engine with the implemented system to access the document result pages based on the selected one of a domain and a subdomain URL 230.

By this method, the externally-hosted search engine may be used with any web site that allows changes to its HTML pages.

The system includes a search engine component supporting category and facet filters as well as full text search capability. An optional user-defined list can be used to explicitly enable or disable any document result page's visibility to web search engines. This may be used to include desirable content and exclude undesirable content from web search engines. In the absence of the user-defined list, pages will be transferred using a traversal of facet filter combinations with a configurable total limit of document result pages transferred. Full text search based pages are automatically enabled based on a configurable minimum user search frequency. The system includes a first component that saves and transfers document result pages to a web server via a file transfer protocol, including but not limited to FTP, SCP, SFTP, FTPS, HTTP, or HTTPS. A file name may be specified for a document result page otherwise a file name will be generated automatically. The system also includes a second component that allows document result page(s) to be manually transferred to a web server. An optional component that tracks changes in search engine data and automatically transfers new updated versions of those document result pages that are altered after search engine data are created or updated. The system also includes a plurality of browser-based scripts that are inserted in the web site HTML. The scripts are used to update the URL in the browser to reflect the URL that accesses the file for those document result pages that are transferred to the web server. If this is not possible in the user's particular browser version, a default indexable URL that web search engines can reference will be used.

In the browser, a browser-based program is used to retrieve the document result page for the query from the hosted web service. If the document result page for the query is not disabled by the user-defined list, the URL in the browser is set to reflect the URL that accesses the file for those document result pages that are transferred to the web server. The user may then reference such a URL in an online forum, discussion, blog, etc. The URL will be accessible to web search engines without impediment as the system has pushed a file for that document result page to the web server. The externally hosted search engine component answers requests for category & facet filters and/or full text searches. If an optional user-defined list is specified, then those document result pages are transferred as files to the web server automatically. Otherwise, a first component allows individual document result pages to be transferred manually instead. An optional second component tracks changes in the search engine data and automatically creates or updates those document result pages when they change as a result of changes in the search engine data.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A system to permit access to a plurality of document pages on a selected one of a domain and a subdomain using a selected one of a domain URL and a subdomain URL, comprising:
a search engine with a full text search or a filter capability;
a first component that saves and transfers said document pages to a web server using a file transfer protocol;
a second component where said document pages are manually transferred to said web server; and
a plurality of browser based scripts that are inserted into said website HTML text to update said browser's displayed URL that accesses corresponding said document pages that are transferred to said web server.

2. The system according to claim 1, wherein said search engine supports a full text search, a plurality of category and a plurality of facet filters.

3. The system according to claim 1, wherein said file transfer protocol is selected from the group consisting of a FTP, a SCP, a SFTP, a FTPS, a HTTPS or a HTTP protocol.

4. The system according to claim 1, wherein said document pages have a specified file name.

5. The system according to claim 4, wherein said specified file name is generated automatically.

6. The system according to claim 1, wherein said browser and said search engine references and utilizes a default indexable URL.

7. The system according to claim 1, wherein said system allows said browser and said search engine to access said document pages on a selected one of a main website domain and a main website subdomain.

8. A system to permit access to a plurality of document pages on a selected one of a domain and a subdomain using a selected one of a domain URL and a subdomain URL, comprising:
a search engine with a full text search or a filter capability;
a user defined list that is utilized to enable or disable a plurality of document
pages visibility to one or more web search engines;
a first component that saves and transfers said document pages to a web server using a file transfer protocol;
a second component where said document pages are manually transferred to said web server; and
a plurality of browser based scripts that are inserted into said website HTML text to update said browser's displayed URL that accesses corresponding said document pages that are transferred to said web server.

9. The system according to claim 8, wherein said search engine supports a full text search, a plurality of category and a plurality of facet filters.

10. The system according to claim 8, wherein said user defined list includes desirable content or exclude undesirable content from said search engine.

11. The system according to claim 10, wherein said document pages are transferred.

12. The system according to claim 11, wherein there is a configurable total limit of said document pages to be transferred.

13. The system according to claim 8, wherein said first component tracks changes in search engine data.

14. The system according to claim 13, wherein said first component automatically transfers new updated and altered document pages.

15. The system according to claim 8, wherein said file transfer protocol is selected from the group consisting of a FTP, a SCP, a SFTP, a FTPS, a HTTPS or a HTTP protocol.

16. The system according to claim 8, wherein said document pages have a specified file name.

17. The system according to claim 16, wherein said specified file name is generated automatically.

18. The system according to claim 8, wherein said browser and said search engine references and utilizes a default indexable URL.

19. The system according to claim 8, wherein said system allows said browser and said search engine to access said document pages on a selected one of a main website domain and a main website subdomain.

20. A method for accessing a plurality of document pages on a selected one of a domain and a subdomain using a selected one of a domain URL and a subdomain URL, comprising the steps of:
accessing a system to access a plurality of document pages on a selected one of a domain and a subdomain using a selected one of a domain URL and a subdomain URL;
implementing said system onto a website; and
utilizing a search engine with said implemented system to access said document pages based on said selected one of a domain URL and said sub domain URL.
